(19) United States
(12) Patent Application Publication
(10) Pub. No.: US 2026/0134631 A1
(43) Pub. Date: May 14, 2026

(54) SYSTEM AND METHOD FOR BACKGROUND REPLACEMENT IN A DIGITAL IMAGE

(71) Applicant: Carvana IPHC, LLC, Tempe, AZ (US)

(72) Inventors: Alan Melling, Tempe, AZ (US); Rajesh Pentyala, Tempe, AZ (US); Antoine Vaucamps, Tempe, AZ (US); Remy Cilia, Tempe, AZ (US); Bruno Francois, Tempe, AZ (US)

(73) Assignee: Carvana IPHC, LLC, Tempe, AZ (US)

(21) Appl. No.: 18/943,553

(22) Filed: Nov. 11, 2024

(51) Int. Cl. G06T 17/20; G06T 15/20; G06T 15/60; G06T 19/00

(52) U.S. Cl. CPC G06T 17/205; G06T 15/20; G06T 15/60; G06T 19/00; G06T 2210/12; G06T 2210/56

(57) ABSTRACT

Systems and methods including one or more processors and one or more non-transitory storage devices storing computing instructions configured to run on the one or more processors and perform acts of generating a point cloud using one or more images of a vehicle; digitally shrink-wrapping the point cloud to generate a shrink-wrapped model of the vehicle; and replacing a background in the one or more images of the vehicle using the shrink-wrapped model of the vehicle, wherein the replaced background comprises a replaced floor. Other embodiments are disclosed herein.

### TECHNICAL FIELD

This disclosure generally relates to digital photography, and more particularly, to digital photography of vehicles.

### BACKGROUND

Visual consistency is important in the online, digital photography of vehicles. To best attract buyers, photos should be consistent enough to allow potential buyers to compare different vehicles, without distracting background elements. Automated photography studios are often used to obtain this consistency, but the use of a studio is not available for every vehicle. For example, many large vehicles (e.g., trucks, vans, etc.) do not fit inside automated photography studios. As another example, when a mobile device is used to capture a 360 degree view of a vehicle, inconsistencies in the path around the vehicle, camera orientation, and user speed around the vehicle can cause distracting variabilities in a resulting 360 degree display on a website. Therefore, a need exists for a new system and method for replacing a background in digital images of a vehicle.

### SUMMARY

A number of embodiments can include a system. The system can include one or more processors and one or more non-transitory computer-readable storage devices. The one or more non-transitory computer-readable storage devices can store computing instructions. The computing instructions can be configured to communicate with the one or more processors and cause the one or more processors to perform generating a point cloud using one or more images of a vehicle; digitally shrink-wrapping the point cloud to generate a shrink-wrapped model of the vehicle; and replacing a background in the one or more images of the vehicle using the shrink-wrapped model of the vehicle, wherein the replaced background comprises a replaced floor.

Various embodiments include a method. The method can be implemented via execution of computing instructions configured to run at one or more processors and/or configured to be stored at non-transitory computer-readable media The method can comprise generating a point cloud using one or more images of a vehicle; digitally shrink-wrapping the point cloud to generate a shrink-wrapped model of the vehicle; and replacing a background in the one or more images of the vehicle using the shrink-wrapped model of the vehicle, wherein the replaced background comprises a replaced floor.

embodiments can include an article of manufacture. The article of manufacture can include a non-transitory, tangible computer readable storage medium. The non-transitory, tangible computer readable storage medium can store instructions that, in response to execution by a computer, cause the computer to perform operations comprising generating a point cloud using one or more images of a vehicle; digitally shrink-wrapping the point cloud to generate a shrink-wrapped model of the vehicle; and replacing a background in the one or more images of the vehicle using the shrink-wrapped model of the vehicle, wherein the replaced background comprises a replaced floor.

### BRIEF DESCRIPTION OF THE DRAWINGS

To facilitate further description of the embodiments, the following drawings are provided:

FIG. 1 illustrates a flowchart for an exemplary method, according to various embodiments.

FIG. 2 illustrates a representative block diagram of an exemplary computer network, according to various embodiments.

FIG. 3 illustrates a representative block diagram of an exemplary computer system, according to various embodiments.

### DESCRIPTION OF EXAMPLES OF EMBODIMENTS

In various embodiments, the elements described below can provide a practical application and several technological improvements. The elements can provide for automated generation of 360 degree views of a vehicle with the background replaced. These elements can provide a significant improvement over conventional approaches of replacing background, such as manual replacement by a graphic artist. For example, the elements can provide for a more accurate identification of a background and replacement of a background. The elements can replace backgrounds in images and/or in 360 degree views of a vehicle based on dynamic information. For example, the elements can be used to replace backgrounds in images of different vehicle makes and/or models in an automated workflow. In this way, these elements can avoid or minimize problems with slow or inconsistent generation of true to life images of a vehicle by a graphic artist. Further, the elements can allow a computer system to replace backgrounds in a way that is different than a graphic artist. For example, a graphic artist does not generate point clouds or digitally shrink-wrap when replacing backgrounds. Instead, the graphic artist may often manually trace an exact outline of the vehicle and replace a remainder of the image.

In various embodiments, the elements can be used continuously at a scale that cannot be reasonably performed using manual functions or the human mind. For example, these elements can be implemented in an automated workflow that allows multiple backgrounds to be replaced in series. Further, multiple true to life images of a vehicle can be generated at the same time using a distributed processing system. In various embodiments, the elements can solve a technical problem that arises only within the realm of computer networks, as digital images and/or digital shrink-wrapping do not exist outside the realm of computer networks.

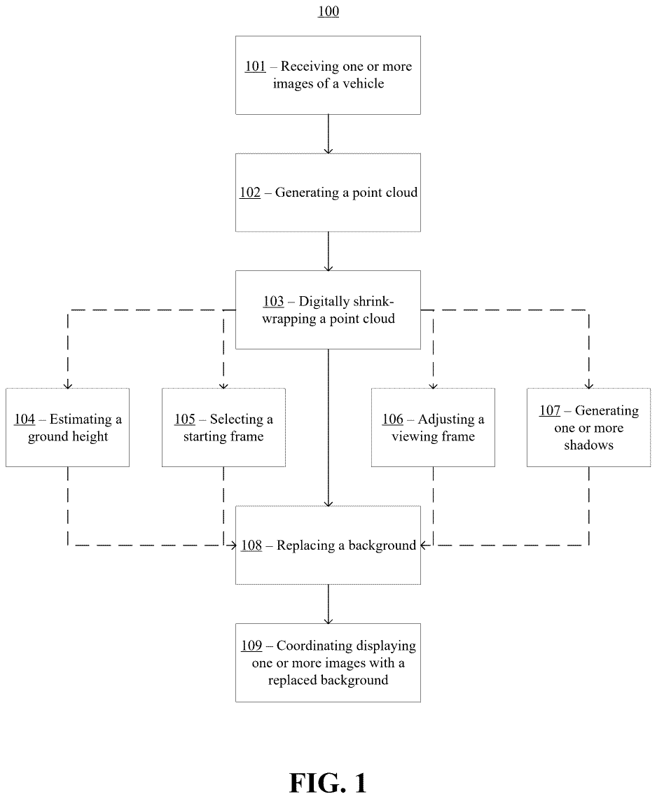

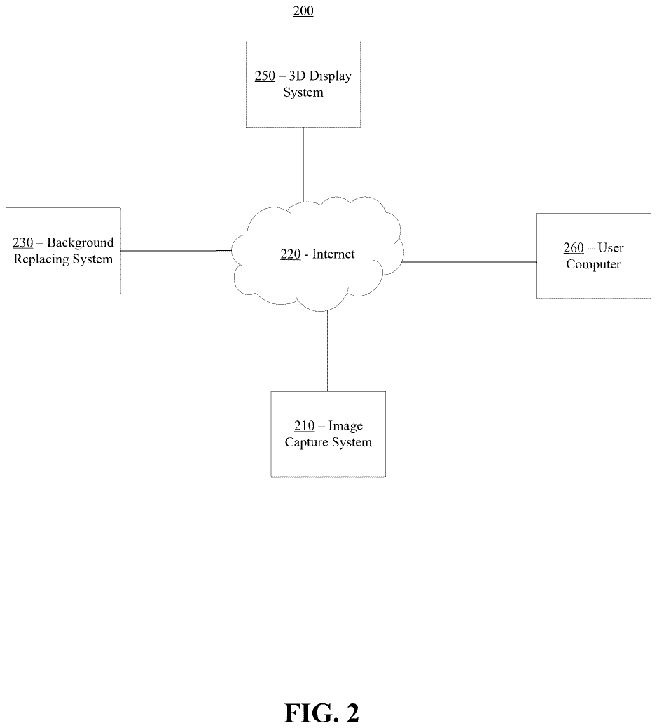

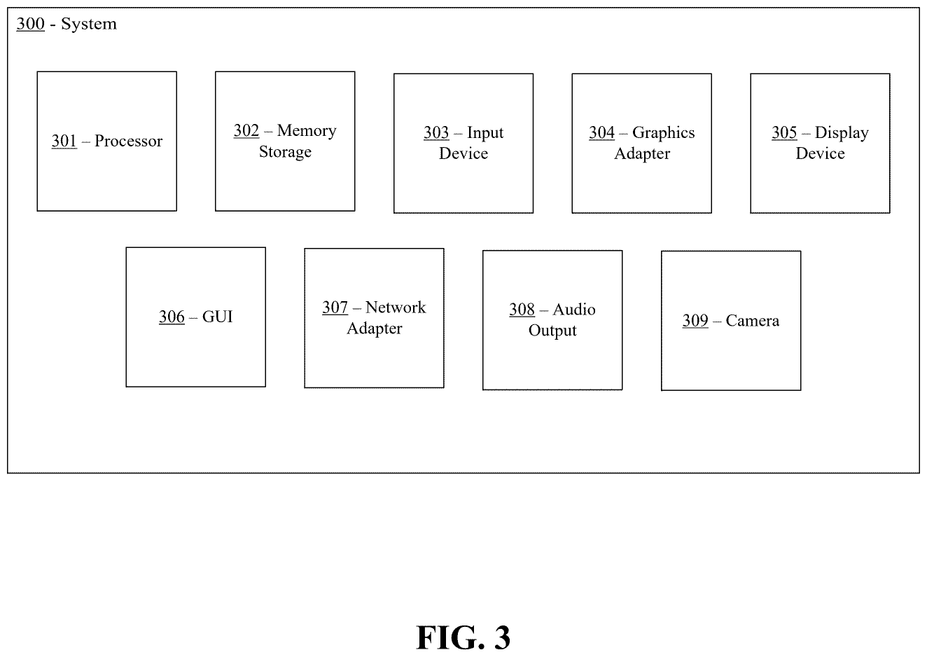

FIG. 1 illustrates a flow chart for a method 100, according to various embodiments. Method 100 is merely exemplary and is not limited to the embodiments presented herein. Method 100 can be employed in many different embodiments or examples not specifically depicted or described herein. In various embodiments, the activities of method 100 can be performed in the order presented. In other embodiments, the activities of method 100 can be performed in any suitable order. In still other embodiments, one or more of the activities of method 100 can be combined or skipped. In various embodiments, system 200 (FIG. 2) or system 300 (FIG. 3) can be suitable to perform method 100 and/or one or more of the activities of method 100. In these or other embodiments, one or more of the activities of method 100 can be implemented as one or more computer instructions configured to run at one or more processing modules and configured to be stored at one or more non-transitory memory storage modules. Such non-transitory memory storage modules can be part of a computer system such as image capture system 210, background replacing system 230, 3D display system 250, and/or user computer 260 (FIG. 2). The processing module(s) can be similar or identical to the processing module(s) described above with respect to computer system 300 (FIG. 3).

In various embodiments, method 100 may comprise an activity 101 of receiving one or more images of a vehicle. Images of a vehicle (e.g., car, truck, motorcycle, boat, airplane, etc.) can be taken in a 3D scanner. For example, an EinScan SE Desktop 3D Scanner, an Afinia EinScan-Pro 2X PLUS Handheld 3D Scanner, and/or an EinScan-SE White Light Desktop 3D Scanner can be used. A 3D scanner can comprise a photography studio configured to create 3D displays. For example, U.S. Pat. No. 10,063,758 and application Ser. Nos. 18/331,605, Ser. No. 18/545,424, Ser. No. 18/544,930, Ser. No. 18/535,071, Ser. No. 18/430,231, Ser. No. 18/789,315, and Ser. No. 17/692,498, which are incorporated herein by this reference in their entirety, describe representative photography studios configured to capture images of a vehicle.

In various embodiments, a 3D scanner can comprise a stage where a vehicle to be photographed is placed. The stage can be located in an interior chamber of a 3D scanner and/or can be placed in an approximate center of a 3D scanner. A stage can be configured to turn a vehicle while a camera captures images. A camera in a 3D scanner can be held in a fixed position or moved around a vehicle while images are captured. For example, a camera can be mounted on a robotic arm (or a rail) and moved around a vehicle. An interior chamber of a 3D scanner can be configured to project uniform, diffused lighting onto a stage. In this way, light reflected off of a vehicle can be minimized or completely eliminated by reducing or eliminating point sources of light. One or more images can be taken in other capture environments that are not a 3D scanner. For example, one or more images can be taken outside or in a building using a handheld camera, a smartphone, a wearable electronic device, and/or some other portable electronic device outfitted with an image sensor and/or camera (e.g., user computer 260 (FIG. 2) and/or system 300 (FIG. 3)). In some embodiments, a human holding an electronic device can walk, run, and/or be transported around a vehicle while capturing images and/or video. In various embodiments, a 3D scanner can be a part of and/or controlled by image capture system 210 (FIG. 2).

In some embodiments, an autonomous vehicle (AV) mounted camera can be used to capture images of a vehicle. An AV can be moved in an approximately circular or elliptical path around a vehicle. The AV can move a camera so that the camera focuses on the vehicle while the AV travels along the path around the vehicle. In many embodiments, an AV can repeat a path around a vehicle at multiple altitudes, heights, and/or depths to capture additional images. In other embodiments, an AV can be outfitted with multiple cameras at different altitudes, heights, and/or depths to capture the additional images.

One or more images can be taken radially around (e.g., around a central axis) of a vehicle. In this way, the one or more images can be taken of the vehicle from multiple angles and/or views, thereby giving a 360 degree view around the vehicle when combined. When a 3D scanner is used, various functions can be used to obtain radially captured images. For example, one or more cameras can be mounted to an approximately circular rail along the circumference of an interior chamber, and these cameras can then be moved around the object while taking photographs. As another example, a stage of a 3D scanner can be configured to rotate while one or more cameras mounted at fixed positions take photographs. One or more cameras in a 3D scanner can be set at multiple levels to capture varied angles of a vehicle at different altitudes, heights, and/or depths. For example, a first camera can be placed on a floor, a second camera can be placed above a vehicle (e.g., directly above and/or angled down at the vehicle), and a third can be placed between the first and the second cameras. In embodiments where a portable electronic device is used to take the one or more images, the portable electronic device and/or a user operating the portable electronic device can be instructed by a software application stored on the portable electronic device to move around an object while taking pictures.

In various embodiments, each image of the one or more images can be associated with a position of a camera that took the image. For example, sensor data (e.g., gyroscope data, accelerometer data, compass data, global positioning system (“GPS”) data) or augmented reality data (e.g., structure-from-motion data) can be associated with each image. Position data for an image can be incorporated into image metadata, sent as a separate file, and/or estimated using one or more structure from the motion functions. For example, position data can be estimated using the well-known COLMAP pipeline of algorithms, which can be located at <https://colmap.github.io/>. Position data can define a value for a camera's six degrees of freedom (e.g., forward/back, up/down, left/right, yaw, pitch, roll), a camera's coordinate position (e.g., on an x, y, z coordinate plane), and/or a camera's focal length. In embodiments where a 3D scanner is used, this positional information can be known in advance (e.g., by preconfiguring a camera's position and orientation) or computed while a vehicle is being photographed. In embodiments where a portable electronic device is used, one or more location tracking modules (e.g., accelerometers, Bluetooth beacons, Wi-Fi location scanning, GPS, etc.) can be used to determine a position of the camera in space. In this way, positional data for each image of the one or more images can be used to orient a camera about the object. One or more images can be captured in and/or received from an image capture system 210 (FIG. 2) and/or user computer 260 (FIG. 2). In these or other embodiments, an image capture system 210 (FIG. 2) can be a part of and/or integrated with a 3D scanner, as described above. In various embodiments, image capture system 210 (FIG. 2) can comprise a software application installed on a computer system (e.g., system 300 (FIG. 3) or user computer 260 (FIG. 2)).

In many embodiments, method 100 can comprise an activity 102 of generating a point cloud. A point cloud can comprise one or more data points in a three-dimensional space that represent a geometry of a vehicle. In some embodiments, activity 102 can occur simultaneously and/or be a part of activity 101. For example, a point cloud can be generated using the well-known COLMAP pipeline of algorithms referenced above. In these embodiments, structure from motion algorithms can generate a point cloud by extracting feature points from the one or more images of a vehicle and tracking these feature points across the one or more images of the vehicle. Additional techniques can also be used to generate a point cloud. For example, a LiDAR system can emit laser pulses and detect reflection of the laser pulses off of the vehicle. 3D coordinates for a point cloud can then be derived from a time-of-flight or phase-shift measurement for the laser pulses and/or their reflections. As another example, photogrammetry techniques can be used to construct a point cloud by analyzing the geometry of how features appear in different images. As a further example, voxel carving techniques can be used to generate a point cloud by iteratively removing portions of a voxel grid that do not match projections of a vehicle in the one or more images. Points can then be added to a surface of the remaining voxel grid As a final example, various probabilistic and/or machine learning techniques can be used to generate a model of a vehicle. Similar to voxel carving, a point cloud can then be added to a surface of the model of the vehicle. In many embodiments, a combination of one or more of the techniques described above can be used to generate a point cloud. For example, a point cloud generated using structure from motion algorithms can be cross referenced with models and/or point clouds generated using one or more probabilistic and/or voxel carving techniques. In these embodiments, feature points present two or more of these techniques can be retained. In this way, a more accurate point cloud can be generated. A feature point can comprise a point in a point cloud that comprises a distinctive, identifiable element and/or characteristic within the point cloud that can be used as a reference marker for analysis.

In some embodiments, point clouds generated using one or more of the examples specified above can be insufficient for downstream activities. For example, there can be an insufficient number of points in the point cloud, which can lead to generation of an inaccurate model. In a more specific example, there can be insufficient and/or improperly placed points near a ground and/or resting surface for the vehicle. In embodiments where point clouds are insufficient, additional techniques can be used to enhance and/or change a point cloud. For example, a bounding box can be placed around a vehicle and the bounding box can be filled with new feature points. In these embodiments, a point cloud shaped like the vehicle can be generated, and these points can be throughout a vehicle volume instead of only on a surface.

In some embodiments, points generated using a bounding box can have no normal vector (e.g., they have no direction). Lack of a normal vector can prevent traditional approaches (e.g., poisson surface reconstruction) from being used for generating a model of a vehicle from a set of feature points. Further, computing a convex hull of points generated using a bounding box can pose problems because a convex hull can often create a mesh between wheels of the vehicle, thereby leaving no space underneath the vehicle and/or generating an inaccurate model of the vehicle for background replacement. Therefore, in many embodiments, method 100 can comprise an activity 103 of digitally shrink-wrapping a point cloud. Shrink-wrapping a point cloud can comprise wrapping a digital mesh onto a surface of a point cloud (e.g., the point cloud generated in activity 102). Shrink-wrapping can proceed by moving a vertex of a digital mesh to a position on a point cloud, thereby allowing the digital mesh to shrink (e.g., conform) to a surface of the point cloud. Once a predetermined or sufficient number of vertices on the digital mesh have been moved (e.g., 1,000 points), a shrink-wrapped model of a vehicle can be generated. A shrink-wrapped model can have a number of advantages over traditional models (e.g., a model created using only a convex hull of a point cloud). For example, a shrink-wrapped model can comprise additional details regarding wheel shape and/or structure. As another example, a shrink-wrapped model can comprise one or more edges delineating all or a part of a running board (if one is present) and/or a bottom edge of a vehicle's body. In this way, a shrink-wrapped model can comprise a concavity located between a front and back wheel and underneath a running board (if one is present) and/or a bottom edge of a vehicle's body.

A number of different techniques can be used to conform vertices of a digital mesh to points on a point cloud. For example, a vertex can be moved to a closest point on a surface of a point cloud. As another example, a vertex can be moved (e.g., projected) along a predetermined axis until it intersects with a point cloud. In many embodiments, a digital mesh can be generated from a bounding box created for a vehicle. A digital mesh can be created from planes of a bounding box by subdividing the planes into smaller shapes. For example, planes of a bounding box can be divided into at least 6,000 triangles. A bounding box for a vehicle can be generated using principal component analysis (PCA). PCA can involve generating a covariance matrix using a set of points centered on a vehicle. A center of a vehicle can be obtained by taking a point cloud for a vehicle and using the point cloud to calculate a centroid (e.g., a mean point) of the point cloud. The centroid can then be subtracted from each point in the point cloud to center positional values for the point cloud on the centroid. A covariance matrix can be considered a matrix describing a distribution of the point cloud along the x, y, and/or z axes. PCA can generate a new coordinate system that aligns with a vehicle's orientation by performing eigenvalue decomposition (a method that transforms the covariance matrix into its normal form) on the covariance matrix to generate eigenvectors (e.g., the principal components of the point cloud) and eigenvalues (e.g., a variance of the point cloud along the principal components) for the point cloud. Points from a point cloud can be transformed into the new coordinate system by multiplying one or more points by an eigenvector. Extremes of the transformed point cloud can comprise minimum and maximum values for the transformed point cloud along the principal components. Extremes of the transformed point clouds can also comprise eight vertices of a bounding box, which can be used to determine the planes of the bounding box.

In some embodiments, a shrink-wrapped digital mesh can have various self-intersections or other topological errors (e.g., due to connections between duplicate points). In many embodiments, a shrink-wrapped digital mesh can comprise a watertight mesh (e.g., a mesh comprising a single closed surface, a mesh with no holes, and/or a mesh that, when filled with water, does not leak). Errors in a shrink-wrapped digital mesh can be minimized and/or corrected in a number of ways. For example, duplicate points in the shrink-wrapped mesh can be deleted to reduce a number of vertices and edges, thereby simplifying a topology of the digital mesh and/or creating a more consistent mesh. Faces within the mesh can also be joined and/or split by an angle delimiter to minimize a number of faces while maintaining an accurate topology, thereby decreasing the amount of processing power needed to use a shrink-wrapped model while at the same time maintaining accuracy of the shrink-wrapped model.

Some vehicles (e.g., those low to the ground and/or with low clearances) can have their shrink-wrapped models extend underground due to issues with the shrink-wrapping process. Therefore, in many embodiments, method 100 can comprise an optional activity 104 of estimating a ground height. Portions of a shrink-wrapped model below the ground height can be removed before and/or during a display to produce a more lifelike image with a replaced background. A ground height can be estimated by identifying a lowest vertex on the shrink-wrapped model that is visible by one or more cameras. In this way, points on the shrink-wrapped model that are underground (e.g., ones that would not be visible if the model replaced the vehicle in the one or more images) can be removed or obfuscated before and/or during a display with a replaced background. A lowest vertex can be identified by casting a ray at one or more vertices from one or more camera locations. A point where one or more rays contact the point before intersecting another point can be deemed to be visible. A point where one or more rays contact another point before intersecting the point can be deemed to be not visible. Once the visible points have been identified, a point lowest on a Z axis can be set as an estimated ground height.

Due to the variability in some captures, it can be difficult to consistently orient a vehicle for consistent downstream displays. For example, paths around a vehicle will start at different positions around the vehicle. As another example, paths around a vehicle can be traveled at different speeds, thereby leading to images captured at different angles around the vehicle. Therefore, in many embodiments, method 100 can comprise an activity 105 of selecting a starting frame. In some embodiments, a starting frame can comprise a view of a vehicle where a display begins. Common starting frames can comprise a front view of a vehicle, a back view of a vehicle, and/or a side view of a vehicle (e.g., a 90 degree rotation from a front of a vehicle or back of a vehicle), but any other view of a vehicle can also be used. A starting frame can be determined using a bounding box for a vehicle (e.g., the bounding box described in activity 103). For example, many vehicles have a length that is longer than a width and/or a height, and this is reflected in dimensions of a bounding box for the vehicle. A longest dimension for a bounding box can be determined, and it can be set as one or more axes (e.g., by rotating the vehicle to one or more of the original axes or creating a new coordinate system). In this way, a front and/or back of a vehicle can be identified. Once a vehicle is oriented (e.g., by identifying a front, side, and/or back), a starting frame can be determined based on administrator preferences by selecting a viewing angle based on the vehicle's orientation. In various embodiments, a starting frame can be used as an origin (e.g., zero degrees of rotation) for downstream activities and/or downstream displays.

Much like selecting a starting frame, it can be difficult to consistently orient a vehicle for consistent downstream displays. For example, a vehicle may not be centered in one or more images of the vehicle or the vehicle may be larger or smaller in one or more images. Due to the variability in some captures, in many embodiments, method 100 can comprise an activity 106 of adjusting a viewing frame. A viewing frame can be adjusted by centering a vehicle in the frame and/or scaling the vehicle in the frame. In order to adjust a view of a vehicle, a rendering camera can be generated that faces and/or tracks a point as it moves about a model (e.g., a shrink-wrapped model) of a vehicle by locking its view towards the point. The rendering camera can be focused on one or more points on the model to determine a minimum and a maximum on each axis for the vehicle. A midpoint can then be determined using the maximum and maximum, which will correspond to an approximate center point of the vehicle. A 3D point can be unprojected (e.g., mapped from a 2D point to a 3D plane) from a rendering camera towards the approximate center at a predetermined distance (e.g., 1 unit), and the rendering camera can then track the unprojected point. In some embodiments, all or a part of activity 106 can be repeated to determine a visually projected center of a vehicle more accurately. In this way, distortions near an edge of a viewing frame can be minimized.

Once a center of a vehicle is determined, a viewing focal length of a rendering camera can be determined that allows the vehicle to be centered and consistently sized in downstream displays. Minimum and/or maximum axis values can be used to determine an axis length (e.g., by subtracting a minimum from a maximum). A ratio of a rendering camera's distance to an approximate center to its axis length can be used to determine a viewing focal length by dividing an original focal length for the rendering camera by the ratio. A view of the vehicle is then adjusted to match the viewing focal length by zooming in and out accordingly.

One way an image of a vehicle with a replaced background can be enhanced is by generating a realistic shadow for the vehicle. Therefore, in many embodiments, method 100 can comprise an activity 107 of generating one or more shadows. In many embodiments, a shrink wrapped model can allow for a shadow to be generated that reflects a size and shape of a vehicle's undercarriage and/or wheel. A shadow created from a shrink-wrapped model can also comprise a contact shadow. For example, a shadow generated from a shrink-wrapped model can collect at a vehicle's wheels and/or create an umbra where a vehicle would block light rays shining on it (e.g., underneath the vehicle, behind one or more wheels, towards a midline of a vehicle from one or more wheels, etc.). In many embodiments, a shape, location, and/or umbra of a shadow can be attributed to one or more aspects of a shrink-wrapped model. For example, an umbra underneath a vehicle and/or behind a wheel can be attributed to wheel structures and/or one or more concavities of a shrink-wrapped model. A shadow generated in activity 107 can be placed at a ground height (e.g., a ground height estimated in activity 104). For example, a shadow catcher layer can be set at a ground height. In this way, a more believable image with a replaced background can be generated by preventing the vehicle from appearing to float above the ground.

Shadows can be generated using a variety of techniques using a shrink-wrapped model of a vehicle. For example, a shadow map can be used to generate a shadow using a shrink-wrapped model of a vehicle. In shadow mapping, a depth map is created from a perspective of a light source for a vehicle by determining a distance from the light source to the 3D model. A shadow mapped shadow can be created by comparing each pixel against a shadow map. If a pixel is farther from a light source than a distance stored in the shadow map, then a shadow is generated for that pixel. As a further example, shadows can be generated using shadow volume techniques. When using shadow volume techniques, a silhouette of a shrink-wrapped model can be extruded into 3D space in a direction of a light ray, thereby creating a shadow volume that extends from the shrink-wrapped model away from the light. A shadow volume can be flattened, and pixels within the flattened shadow volume can be considered in shadow.

As another example, ray tracing techniques can be used to generate a shadow using a shrink wrapped model of a vehicle. In ray tracing, rays are cast from a camera to a shrink-wrapped model of a vehicle and/or a plane placed at ground height (e.g., a shadow catching layer). When a surface is hit, secondary rays can be traced from that surface point toward the light source. A surface point can be considered in shadow when an object obstructs the secondary ray to the light. Path tracing techniques can also be used to generate a shadow. Path tracing techniques can be similar to ray tracing techniques, but also take into account interactions from reflections, refractions, and/or indirect light. Path tracing techniques track rays as they bounce around a scene and inherit physical based rendering effects from surfaces. Path tracing techniques can be used to produce softer and more detailed shadows using a shrink-wrapped model. In many embodiments, method 100 can comprise an activity 108 of replacing a background. In some embodiments, activity 108 can be performed after one or more of activities 104-106. In other embodiments, one or more of activities 104-106 can be skipped. A background for a vehicle can be replaced using a shrink-wrapped model of the vehicle. For example, portions of one or more images that are not the shrink-wrapped model can be deemed as the background and therefore replaced. For example, a background can be replaced by selecting the model and removing a remainder of the image. As another example, a background can be replaced by cutting a model out of an image and initializing a new image with the cut-out model. As a further example, a background can be identified and other images can be overlaid on top of it. A background can be replaced in a number of different ways. For example, a blurred version of the background can be put in place of an original background. As another example, a whitened (e.g., desaturated) version of the background can be put in place of an original background. A background can also be replaced with a version that has a colored overlay applied at a number of different opacity levels. For example, a new background can be generated by applying a 70% opaque white overlay to an original background. As another example, a fully opaque background can be generated by applying a 100% opaque overlay. A synthetic scene can also be used to replace an original background. For example, a synthetic scene can comprise a forest, a cliffside, and/or a cityscape. In this way, a vehicle can be displayed in a number of different environments.

In many embodiments, a replaced background can comprise a simulated interior of a 3D scanner and/or a simulated interior of a photography studio described above. For example, a circular and/or gray floor can be added to a portion of a replaced background. In many embodiments, a floor can be added at one or more ground heights (e.g., a ground height estimated in activity 104). In some embodiments, a floor can be added at a horizon line of an image. In these embodiments, a vehicle can be placed at a ground height while a floor color extends above towards a horizon. In this way, issues with a vehicle appearing to float above a floor and/or its shadow can be avoided. In some embodiments, one or more curves of a floor can be blurred to prevent aliasing (e.g., stair stepping along the curve). In this way, a more realistic image can be generated. In various embodiments, a replaced background can have one or more graphics added. For example, a logo, price, or features list can be added to a replaced background. In some embodiments, a graphic can be placed at least partially behind and/or be at least partially cut off by a floor (when one is used).

In many embodiments, method 100 can comprise an activity 109 of coordinating displaying the one or more images of the vehicle with a replaced background. One or more images with a replaced background can be displayed on a website and/or through a mobile application configured for viewing vehicles. Images with replaced backgrounds can also be displayed locally on a rendering device and/or transferred to another electronic device for viewing at a later time. In many embodiments, a 360 degree display of a vehicle can be generated using one or more images with replaced backgrounds. The 360 degree display can iterate through the one or more images of a vehicle with replaced backgrounds as a user navigates through the 360 degree display. In embodiments, when a user stops the 360 degree view on a view in-between the one or more images, the 360 degree display can be automatically navigated to a closest image of the one or more images in the view. In various embodiments, automatic navigation can be in a direction of navigation selected by the user. For example, if a user is rotating clockwise, then the automatic navigation can be to a next image in a clockwise direction. In these or other embodiments, automatic navigation can comprise a faster navigation than user selected navigation.

Turning ahead in the drawings, FIG. 2 illustrates a block diagram of a system 200 that can be employed replacing a background, as described in greater detail below. System 200 is merely exemplary and embodiments of the system are not limited to the embodiments presented herein. System 200 can be employed in many different embodiments or examples not specifically depicted or described herein. In various embodiments, certain elements or modules of system 200 can perform various procedures, processes, and/or activities. In these or other embodiments, the procedures, processes, and/or activities can be performed by other suitable elements or modules of system 200.

Generally, therefore, system 200 can be implemented with hardware and/or software, as described herein. In various embodiments, part or all of the hardware and/or software can be conventional, while in these or other embodiments, part or all of the hardware and/or software can be customized (e.g., optimized) for implementing part or all of the functionality of system 200 described herein.

In various embodiments, system 200 can include an image capture system 210, a background replacing system 230, a 3D display system 250, and/or a user computer 260. Image capture system 210, background replacing system 230, 3D display system 250, and/or user computer 260 can each be a computer system, such as computer system 300 (FIG. 3), as described below, and can each be a single computer, a single server, or a cluster or collection of computers or servers, or a cloud of computers or servers. In another embodiment, a single computer system can host each of two or more of image capture system 210, background replacing system 230, 3D display system 250, and/or user computer 260. Additional details regarding image capture system 210, background replacing system 230, 3D display system 250, and/or user computer 260 are described herein.

In various embodiments, each of image capture system 210, background replacing system 230, 3D display system 250, and user computer 260 can be a separate system, such as computer system 300 (FIG. 3). In other embodiments, or two or more of image capture system 210, background replacing system 230, 3D display system 250, and user computer 260 can be combined into a single system, such as computer system 300 (FIG. 3). In any of the embodiments described in this paragraph, each separate system can be operated by a different entity or by a single entity, or two or more of each separate system can be operated by the same entity.

As noted above, system 200 can comprise user computer 260. In other embodiments, user computer 260 is external to system 200. User computer 260 can comprise any of the elements described in relation to computer system 300 (FIG. 3). In various embodiments, user computer 260 can be a mobile electronic device. A mobile electronic device can refer to a portable electronic device (e.g., an electronic device easily conveyed by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For example, in various embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In various embodiments, system 200 can comprise a graphical user interface (“GUI”). In the same or different embodiments, a GUI can be part of and/or displayed by image capture system 210, background replacing system 230, 3D display system 250, and/or user computer 260, and also can be part of system 200. In various embodiments, a GUI can comprise text and/or graphics (image) based user interfaces. In the same or different embodiments, a GUI can comprise a heads up display (“HUD”). When a GUI comprises a HUD, the GUI can be projected onto glass or plastic, displayed in midair as a hologram, or displayed on a display. In various embodiments, a GUI can be color, black and white, and/or greyscale. In various embodiments, a GUI can comprise an application running on a computer system, such as computer system 300 (FIG. 3), image capture system 210, background replacing system 230, 3D display system 250, and/or user computer 260. In the same or different embodiments, a GUI can comprise a website accessed through internet 220. In various embodiments, a GUI can comprise an eCommerce website. In these or other embodiments, a first GUI can comprise an administrative (e.g., back end) GUI allowing an administrator to modify and/or change one or more settings in system 200 while another GUI can comprise a consumer facing (e.g., a front end) GUI. In the same or different embodiments, a GUI can be displayed as or on a virtual reality (VR) and/or augmented reality (AR) system or display. In various embodiments, an interaction with a GUI can comprise a click, a look, a selection, a grab, a view, a purchase, a bid, a swipe, a pinch, a reverse pinch, etc.

In various embodiments, image capture system 210, background replacing system 230, 3D display system 250, and/or user computer 260 can be in data communication through internet 220 with each other and/or with user computer 260. In certain embodiments, as noted above, user computer 260 can be desktop computers, laptop computers, smart phones, tablet devices, and/or other endpoint devices. Image capture system 210, background replacing system 230, and/or 3D display system 250 can host one or more websites. For example, 3D display system 250 can host an eCommerce website that allows users to browse and/or search for products, to add products to an electronic shopping cart, and/or to purchase products, in addition to other suitable activities.

In various embodiments, image capture system 210, background replacing system 230, 3D display system 250, and/or user computer 260 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can comprise a keyboard and/or a mouse. Further, one or more of the display device(s) can comprise a monitor and/or embedded screen. The input device(s) and the display device(s) can be coupled to the processing module(s) and/or the memory storage module(s) image capture system 210, background replacing system 230, 3D display system 250, and/or user computer 260 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In various embodiments, the KVM switch also can be part of image capture system 210, background replacing system 230, 3D display system 250, and/or user computer 260. In a similar manner, the processing module(s) and the memory storage module(s) can be local and/or remote to each other.

As noted above, image capture system 210, background replacing system 230, 3D display system 250, and/or user computer 260 can be configured to communicate with user computer 260. In various embodiments, user computer 260 also can be referred to as customer computers. In various embodiments, image capture system 210, background replacing system 230, 3D display system 250, and/or user computer 260 can communicate or interface (e.g., interact) with one or more customer computers (such as user computer 260) through a network or internet 220. Internet 220 can be an intranet that is not open to the public. In further embodiments, Internet 220 can be a mesh network of individual systems. Accordingly, In various embodiments, image capture system 210, background replacing system 230, and/or 3D display system 250 (and/or the software used by such systems) can refer to a back end of system 200 operated by an operator and/or administrator of system 200, and user computer 260 (and/or the software used by such systems) can refer to a front end of system 200 used by one or more users. In these embodiments, the components of the back end of system 200 can communicate with each other on a different network than the network used for communication between the back end of system 200 and the front end of system 200. In various embodiments, the users of the front end of system 200 can also be referred to as customers, in which case, user computer 260 can be referred to as a customer computer. In these or other embodiments, the operator and/or administrator of system 200 can manage system 200, the processing module(s) of system 200, and/or the memory storage module(s) of system 200 using the input device(s) and/or display device(s) of system 200.

Meanwhile, In various embodiments, image capture system 210, background replacing system 230, 3D display system 250, and/or user computer 260 also can be configured to communicate with one or more databases. The one or more databases can comprise a product database that contains information about products, items, vehicles (e.g., make, model, VIN, year, style, body type drivetrain, fuel economy, fuel type, etc.), or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 300 (FIG. 3). Also, in various embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database.

Meanwhile, communication between image capture system 210, background replacing system 230, 3D display system 250, and/or user computer 260, and/or the one or more databases can be implemented using any suitable manner of wired and/or wireless communication. Accordingly, system 200 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. ; exemplary LAN and/or WAN protocol(s) can comprise Institute of Electrical and Electronic Engineers (IEEE) 802.3 (also known as Ethernet), IEEE 802.11 (also known as WiFi), etc. ; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In various embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

Turning ahead in the drawings, FIG. 3 illustrates a block diagram of a system 300 that can be employed for generating an image of an automobile, as described in greater detail below. System 300 is merely exemplary and embodiments of the system are not limited to the embodiments presented herein. System 300 can be employed in many different embodiments or examples not specifically depicted or described herein. In various embodiments, certain elements or modules of system 300 can perform various procedures, processes, and/or activities. In these or other embodiments, the procedures, processes, and/or activities can be performed by other suitable elements or modules of system 300.

Generally speaking, system 300 can be implemented with hardware and/or software. Part or all of the hardware and/or software implemented in system 300 can be conventional or part or all of the hardware and/or software can be customized (e.g., optimized) for implementing part or all of the functionality of system 300 described herein. When implemented as software, one or more elements of system 300 can be emulated (e.g., reproduced functionally and/or by action via software). For example, a virtual machine having one or more elements described below can be instantiated on one or more elements of system 200 (FIG. 2).

When implemented as hardware, one or more of the elements of system 300 can be coupled together using one or more chassis configured to hold one or more circuit boards and/or serial bus(es). These boards and buses allow the various elements of system 300 to communicate amongst each other to accomplish their intended purposes. While elements of system 300 are described below individually, each can also be integrated into one or more chassis, circuit boards, and/or buses of system 300. On the other hand, one or more elements of system 300 can also be removable (e.g., via a PCI slot on a motherboard and/or a USB port). One or more elements of system 300 may also be integrated and/or embedded in a different machine or manufacture. Although specific constructions of boards and buses within system 300 are not shown, it should be understood that their construction can be tied to a form factor selected for system 300.

System 300 can take a number of different form factors based on its implementation. For example, system 300 can be implemented as a desktop computer, a laptop computer, a mobile device, and/or a wearable device as described herein. Further, system 300 can comprise a single computer, a single server, a cluster or collection of computers or servers, or a cloud of computers or servers. Typically, a cluster or collection of servers can be used when the demand on 300 exceeds the reasonable capability of a single server or computer, when a distributed structure for system 300 is desired, and/or when parallel computing is desired.

In various embodiments, system 300 can comprise a processor 301, a memory storage 302, an input device 303, a graphics adapter 304, a display device 305, a graphical user interface (GUI) 306, a network adapter 307, and/or an audio output 308.

Generally speaking, processor 301 can comprise any type of computational circuit. For example, processor 301 can comprise a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, application specific integrated circuits (ASICs), etc. Processor 301 can be configured to implement (e.g., run) computer instructions (e.g., program instructions) stored on memory devices in system 300. At least a portion of the program instructions, stored on these devices, can be suitable for carrying out at least part of the functions and methods described herein. Architecture and/or design of processor 301 can be compliant with any of a variety of commercially distributed architecture families. For example, a processor can have a 32-bit (x86) architecture and/or a 64-bit (x86-64, IA64, and AMD64) architecture. Processor 301 can be configured to perform parallel computing in combination with other elements of system 300 and/or additional processors. Generally speaking, parallel computing can be seen as a technique where multiple elements of system 300 are used to perform calculations simultaneously. In this way, complex and repetitive tasks (e.g., training a predictive algorithm) can be performed faster and with less processing power than without parallel computing.

Generally speaking, memory storage 302 can comprise non-volatile memory (e.g., read only memory (ROM)) and/or volatile memory (e.g., random access memory (RAM)). The non-volatile memory can be removable and/or non-removable non-volatile memory. Meanwhile, RAM can comprise dynamic RAM (DRAM), static RAM (SRAM), or some other type of RAM. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), or some other type of ROM. Memory storage 302 can comprise non-transitory memory and/or transitory memory. All or a portion of memory storage 302 can be referred to as memory storage module(s) and/or memory storage device(s). Memory storage 302 can have a number of form factors when used in system 300. For example, memory storage 302 can comprise a magnetic disk hard drive, a solid state hard drive, a removable USB storage drive, a RAM chip, etc.

Memory storage 302 can be encoded with a wide variety of computer code configured to operate system 300. For example, portions of memory storage 302 can be encoded with a boot code sequence suitable for restoring system 300 to a functional state after a system reset. As another example, portions of memory storage 302 can comprise microcode such as a Basic Input-Output System (BIOS) operable with elements of system 300. Further, portions of the memory storage 302 can comprise an operating system (e.g., a software program that manages the hardware and software resources of a computer and/or a computer network). The BIOS can be configured to initialize and test components of system 300 and load the operating system. Meanwhile, the operating system can perform basic tasks such as, for example, controlling and allocating memory, prioritizing the processing of instructions, controlling input and output devices, facilitating networking, and/or managing files. Exemplary operating systems can comprise software within the Microsoft® Windows®, Mac OS®, Apple® iOS®, Google® Android®, UNIX®, and/or Linux® series of operating systems.

Input device 303 can be configured to allow a user to interact and/or control elements of system 300. A number of devices can be used as input device 303 alone or in combination. For example, input device 303 can comprise a keyboard, a mouse, a touch screen, a microphone, a camera, etc. Input device 303 can be coupled to other elements of system 300 in a number of ways. For example, input device 303 can be coupled via a Universal Serial Bus (USB) port in a wired and/or wireless manner or via a specialized port (e.g., a PS/2 port) depending on the specific device. User inputs through input device 303 can come in a number of forms. For example, when input device 303 comprises a microphone, user input can be received via voice commands and/or a speech to text algorithm. As another example, when input device 303 comprises a camera, user input can be received via bodily movements that are captured and interpreted by system 300.

Generally speaking, graphics adapter 304 can be configured to receive and/or generate one or more elements for display on display device 305. Exemplary embodiments of graphics adapter 304 can comprise devices within the NVIDIA® GeForce® and/or the AMD® RX® series of video cards. In various embodiments, a chipset present on graphics adapter 304 can be configured to perform similar, simultaneous computations in a manner more efficient than other chipsets. For example, rendering a 3D scene on graphics adapter 304 can involve repeated geometric calculations performed in parallel to generate the 3D scene. As another example, repeated mathematical calculations involved in training a predictive algorithm can be performed in parallel on graphics adapter 304 more efficiently than on processor 301. Display device 305 can receive and display signals from graphics adapter 304. A number of devices can be used as display device 305. For example, display device 305 can comprise a computer monitor, a television, a touch screen display, a heads up display (HUD) medium, etc.

In various embodiments, display device 305 can optionally display graphical user interface (GUI) 306. GUI 306 can be a part of and/or displayed by one or more web devices 202-203 (FIG. 2). GUI 306 (or elements thereof) can also be stored 3D display system 250 and/or user computer 260. With regards to form, GUI 306 can comprise text and/or graphics (image) based user interfaces. For example, GUI 306 can comprise GUI 500 (FIG. 5)). As another example, GUI 306 can comprise a heads up display (HUD). When GUI 306 comprises a HUD, GUI 306 can be projected onto a medium (e.g., glass, plastic, metal, etc.), displayed in midair as a hologram, and/or displayed on display device 305. GUI 306 can be color, black and white, and/or greyscale. GUI 306 can be implemented as an application running on a computer system, such as 3D display system 250 and/or user computer 260. GUI 306 can also comprise a website accessed through a network (e.g., internet 220 (FIG. 2)). For example, GUI 306 can comprise a website or installed software application. When GUI 306 allows for modification and/or changes to one or more settings in system 300, it can be referred to as an administrative (e.g., back end) GUI. GUI 306 can also be displayed as or on a virtual reality (VR) and/or augmented reality (AR) system or display. GUI 306 can receive a number of interactions from a user via input device 303. For example, an interaction with a GUI can comprise a click, a look, a selection, a grab, a view, a purchase, a bid, a swipe, a pinch, a reverse pinch, etc.

Network adapter 307 can be configured to connect system 300 to a computer network by wired communication (e.g., a wired network adapter) and/or wireless communication (e.g., a wireless network adapter). Network adapter 307 can be integrated into one or more chassis, circuit boards, and/or buses or be removable (e.g., via a PCI slot on a motherboard). For example, network adapter 307 can be implemented via one or more dedicated communication chips configured to receive various protocols of wired and/or wireless communications. Audio output 308 can be configured to receive and/or generate one or more audio signals for play through a speaker and/or microphone. Exemplary audio outputs can comprise an audio card.

Camera 309 can comprise a variety of internal and external cameras capable of capturing digital images. For example, camera 309 can comprise a digital single-lens reflex (DSLR) camera, a mirrorless camera, a point-and-shoot camera, a video camera, a bridge camera, an action camera, a 360-degree camera, a medium format camera, a smartphone camera, a drone camera, etc. Camera 309 can communicate with additional elements of system 300 via wired and/or wirelessly communication. When wired, camera 309 can be integrated into system 300 (e.g., a smartphone camera) or coupled via one or more removable cables. Camera 309 can comprise one or more removable storage mediums capable of transferring stored photographs for transfer to other systems.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although systems and methods for background replacement have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory memories storing computing instructions configured to communicate with the one or more processors and cause the one or more processors to perform:
generating a point cloud using one or more images of a vehicle;
digitally shrink-wrapping the point cloud to generate a shrink-wrapped model of the vehicle; and
replacing a background in the one or more images of the vehicle using the shrink-wrapped model of the vehicle, wherein the replaced background comprises a replaced floor.

2. The system of claim 1, wherein the digitally shrink-wrapping the point cloud comprises wrapping a digital mesh onto the point cloud.

3. The system of claim 2, wherein the digitally shrink-wrapping the point cloud comprises removing duplicate points in the digital mesh to generate the shrink-wrapped model of the vehicle.

4. The system of claim 1 further comprising generating one or more shadows using the shrink-wrapped model of the vehicle, wherein the one or more shadows comprise an umbra underneath the vehicle and behind one or more wheels of the vehicle.

5. The system of claim 1 further comprising estimating a ground height in the one or more images of the vehicle using the shrink-wrapped model of the vehicle.

6. The system of claim 1 further comprising selecting a starting frame for the one or more images of the vehicle using a bounding box for the vehicle.

7. The system of claim 1 further comprising adjusting a viewing frame of the one or more images of the vehicle using the shrink-wrapped model of the vehicle.

8. A method comprising:
generating a point cloud using one or more images of a vehicle;
digitally shrink-wrapping the point cloud to generate a shrink-wrapped model of the vehicle; and
replacing a background in the one or more images of the vehicle using the shrink-wrapped model of the vehicle, wherein the replaced background comprises a replaced floor.

9. The method of claim 8, wherein the digitally shrink-wrapping the point cloud comprises wrapping a digital mesh onto the point cloud.

10. The method of claim 9, wherein the digitally shrink-wrapping the point cloud comprises removing duplicate points in the digital mesh to generate the shrink-wrapped model of the vehicle.

11. The method of claim 8 further comprising generating one or more shadows using the shrink-wrapped model of the vehicle, wherein the one or more shadows comprise an umbra underneath the vehicle and behind one or more wheels of the vehicle.

12. The method of claim 8 further comprising estimating a ground height in the one or more images of the vehicle using the shrink-wrapped model of the vehicle.

13. The method of claim 8 further comprising selecting a starting frame for the one or more images of the vehicle using a bounding box for the vehicle.

14. The method of claim 8 further comprising adjusting a viewing frame of the one or more images of the vehicle using the shrink-wrapped model of the vehicle.

15. One or more articles of manufacture including one or more non-transitory, tangible computer readable storage mediums having instructions stored thereon that, in response to execution by one or more processors, cause the one or more processors to perform:
generating a point cloud using one or more images of a vehicle;
digitally shrink-wrapping the point cloud to generate a shrink-wrapped model of the vehicle; and
replacing a background in the one or more images of the vehicle using the shrink-wrapped model of the vehicle, wherein the replaced background comprises a replaced floor.

16. The one or more articles of manufacture of claim 15, wherein the digitally shrink-wrapping the point cloud comprises wrapping a digital mesh onto the point cloud.

17. The one or more articles of manufacture of claim 16, wherein the digitally shrink-wrapping the point cloud comprises removing duplicate points in the digital mesh to generate the shrink-wrapped model of the vehicle.

18. The one or more articles of manufacture of claim 15 further comprising generating one or more shadows using the shrink-wrapped model of the vehicle, wherein the one or more shadows comprise an umbra underneath the vehicle and behind one or more wheels.

19. The one or more articles of manufacture of claim 15 further comprising estimating a ground height in the one or more images of the vehicle using the shrink-wrapped model of the vehicle.

20. The one or more articles of manufacture of claim 15 further comprising selecting a starting frame for the one or more images of the vehicle using a bounding box for the vehicle.
